(19) United States
(12) Patent Application Publication
(10) Pub. No.: US 2007/0285403 A1
(43) Pub. Date: Dec. 13, 2007

(54) DISPLAY APPARATUS AND DRIVING METHOD

(76) Inventors: Shinichi Aota, Ishikawa-gun (JP); Kazuhiro Nishiyama, Kanazawa-shi (JP); Mitsutaka Okita, Hakusan-shi (JP); Shigesumi Araki, Ishikawa-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/760,940

(22) Filed: Jun. 11, 2007

(30) Foreign Application Priority Data
Jun. 12, 2006 (JP) 2006-162645

(51) Int. Cl. G06F 3/041

(52) U.S. Cl. 345/173

(57) ABSTRACT

A display apparatus includes a display panel in which pixels are arranged in a matrix, a light source which is provided to face the display panel and illuminates one face of the display panel, selecting means which is provided between the display panel and the light source and is configured to transmit or reflect light, and control means for generating a frame which is time-shared by a transmissive display state produced by light from the light source, transmissive control of the selecting means, and display control of the display panel, and a reflective display state produced by reflective control of the selecting means and display control of the display panel.

### CROSS-REFERENCE TO RELATED APPLICATIONS

This application is based upon and claims the benefit of priority from prior Japanese Patent Application No. 2006-162645, filed Jun. 12, 2006, the entire contents of which are incorporated herein by reference.

### BACKGROUND OF THE INVENTION

1. Field of the Invention

This invention relates to a display apparatus capable of improving the use efficiency of light and a method of driving the display apparatus.

2. Description of the Related Art

A flat-panel display device typified by a liquid-crystal display device has been widely used as a display device for a personal computer, an information mobile terminal, a television, a car navigation system, or the like, because of its advantages of lightweight, thinness, and low-power consumption.

In the liquid-crystal display device, a large number of pixels are arranged in a matrix and the light transmittance of each of the pixels is controlled, thereby displaying an image. According to the mode of using light, a transmissive liquid-crystal display device, a reflective liquid-crystal display device, and a transreflective liquid-crystal display device are known as the types of liquid-crystal display devices.

In the transmissive liquid-crystal display device, an illuminating device called a backlight is provided on the backside of a display panel and the amount of transmission of the light is controlled, thereby displaying an image. Although the transmissive liquid-crystal display device provides good visibility even in a dark environment, the power consumption accounts for more than half of the total power consumption of the display device. In a lighted environment, to secure a sufficient visibility, the light quantity of the light source of the backlight has to be made fairly large, which is not practical from the viewpoint of power consumption.

The reflective liquid-crystal display device takes in light from the outside of the display device, causes the light to reflect inside the display panel, and controls the amount of reflection, thereby displaying an image. For this reason, although the reflective liquid-crystal display device can realize lower power consumption than the transmissive liquid-crystal display device, it has a problem: the user cannot recognize what is displayed on the device in a dark place where the amount of outside light is small.

In the transreflective liquid-crystal display device, a reflecting part which displays an image by reflecting ambient light and a transmissive part which displays an image by causing light of a backlight to pass through, are provided in a pixel. This makes it possible to make a transmissive display function and a reflective display function compatible with each other (Jpn. Pat. Appln. KOKAI Publication No. 2005-62573).

### BRIEF SUMMARY OF THE INVENTION

According to a first aspect of the invention, there is provided a display apparatus comprising: a display panel in which pixels are arranged in a matrix; a light source which is provided to face the display panel and illuminates one face of the display panel; selecting means which is provided between the display panel and the light source and is configured to transmit or reflect light; and control means for generating a frame which is time-shared by a transmissive display state produced by light from the light source, transmissive control of the selecting means, and display control of the display panel, and a reflective display state produced by reflective control of the selecting means and display control of the display panel.

According to a second aspect of the invention, there is provided a method of driving a display apparatus which includes a display panel in which pixels are arranged in a matrix, a light source which is provided face the display panel and illuminates one face of the display panel, selecting means which is provided between the display panel and the light source and is configured to transmit or reflect light, and control means which controls the display of the display panel and the transmission or reflection of the selecting means, wherein the control means makes time division using a transmissive display state produced by light from the light source, transmissive control by the selecting means, and display control of the display panel and a reflective display state produced by reflective control by the selecting means and display control of the display panel, thereby creating a frame.

Additional objects and advantages of the invention will be set forth in the description which follows, and in part will be obvious from the description, or may be learned by practice of the invention. The objects and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view schematically showing a liquid-crystal display device according to an embodiment of the invention;

FIG. 2 schematically shows the configuration of a circuit of the liquid-crystal display device according to the embodiment;

FIG. 3 schematically shows the configuration of a source driver shown in FIG. 1;

FIG. 4A is a diagram to help explain the principle of switching transmissive states of polymer-dispersed liquid crystals;

FIG. 4B is a diagram to help explain the principle of switching transmissive states of polymer-dispersed liquid crystals;

FIG. 5 is a diagram to help explain the display operation of the liquid-crystal display device;

FIG. 6 is a time chart to help explain the display operation of the liquid-crystal display device;

FIG. 7A is a diagram to help explain the principle of switching transmissive states by use of cholesteric liquid crystals;

FIG. 7B is a diagram to help explain the principle of switching transmissive states by use of cholesteric liquid crystals;

FIG. 8A is a diagram to help explain the principle of switching transmissive states by use of liquid-crystal cells; and

FIG. 8B is a diagram to help explain the principle of switching transmissive states by use of liquid-crystal cells.

### DETAILED DESCRIPTION OF THE INVENTION

Hereinafter, referring to the accompanying drawings, a display apparatus according to the invention will be explained, taking a liquid-crystal display device as example.

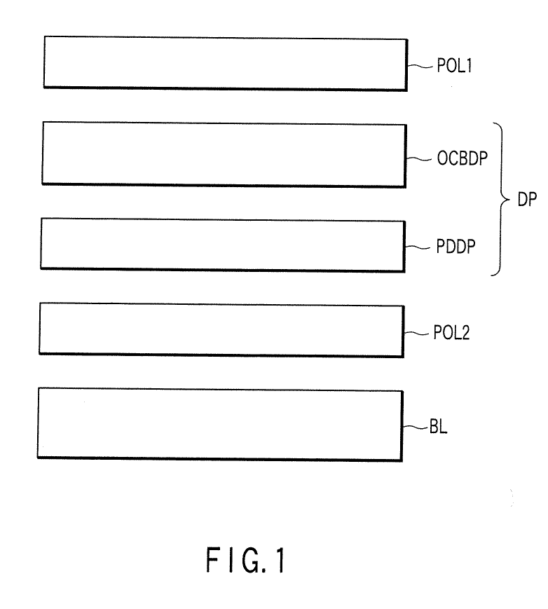

As shown in FIG. 1, a liquid-crystal display device comprises a display panel DP, a first polarizing element POLL arranged on the view plane side of the display panel DP, a backlight BL for illuminating the display panel DP, and a second polarizing element POL2 arranged between the display panel DP and backlight BL.

The display panel DP is composed of a liquid-crystal display panel OCBDP to which OCB liquid crystals have been applied and a liquid-crystal display panel PDDP to which Polymer Dispersed Liquid Crystals (PDLC) have been applied.

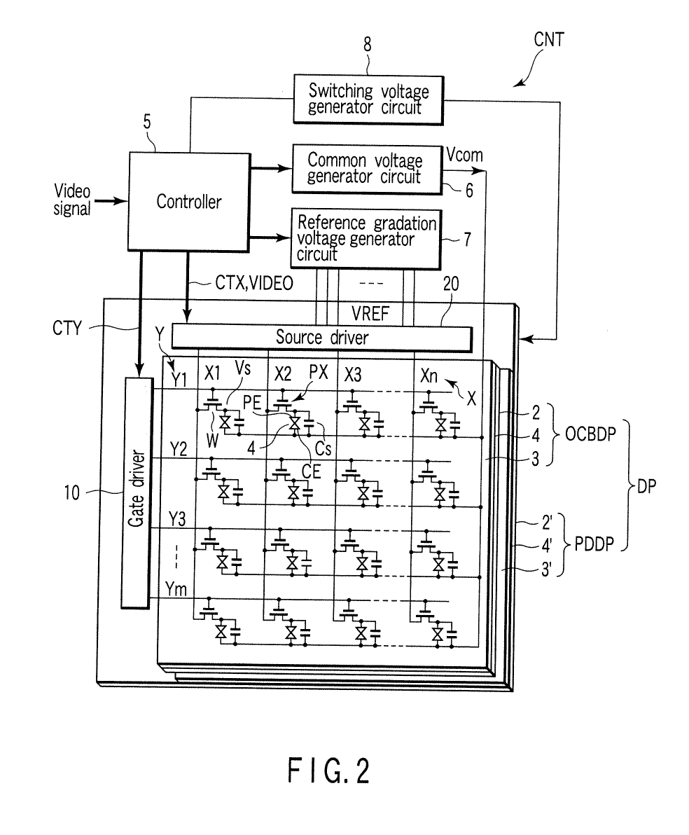

FIG. 2 schematically shows the configuration of a circuit of the liquid-crystal display device.

In the display panel DP, a liquid-crystal display panel OCBD having a plurality of OCB liquid-crystal pixels PX, a liquid-crystal display panel PDDP, and a control unit CNT for controlling the display panel DP are provided.

The liquid-crystal display panel OCBDP has a structure where an OCB liquid-crystal layer 4 is held between an array substrate 2 and a counter-substrate 3.

Similarly, the liquid-crystal display panel PDDP has a structure where a PDLC layer 4′ is held between an array substrate 2′ and a counter-substrate 3′.

Next, the configuration of the liquid-crystal display panel OCBDP will be explained.

The liquid-crystal display panel OCBDP includes a plurality of pixel electrodes PE, a plurality of gate lines Y (Y1 to Ym), a plurality of source lines X (X1 to Xn), pixel switching elements W, a gate driver 10, and a source driver 20.

The pixel electrodes PE are arranged in a matrix on a transparent insulating substrate, such as glass. The gate lines Y (Y1 to Ym) are arranged along a row of a plurality of pixel electrodes PE. The source lines X (X1 to Xn) are arranged along a column of a plurality of pixel electrodes PE. The pixel switching elements W are arranged near the intersections of the gate lines Y and source lines X. The gate driver 10 drives a plurality of gate lines Y sequentially at a rate of a line in a horizontal display period. The source driver 20 drives a plurality of source lines X, while each gate line Y is being driven.

Each of the pixel switching elements W is composed of, for example, a polysilicon thin-film transistor. In this case, the gate of the thin-film transistor is connected to a gate line Y and the source-drain path of the thin-film transistor is connected between a source line X and a pixel electrode PE. The gate driver 10 is formed using a polysilicon thin-film transistor formed simultaneously in the same process as the pixel switching element W. The source driver 20 is an integrated-circuit (IC) chip mounted by COG (Chip On Glass) techniques.

The counter-substrate 3 includes a color filter (not shown) arranged on a transparent insulating substrate, such as glass, and a common electrode CE and others arranged on the color filter so as to face a plurality of pixel electrodes PE.

Each of the pixel electrodes PE and the common electrode CE are made of a transparent electrode material, such as ITO. Between the pixel electrodes PE and common electrode CE, there is provided a liquid-crystal layer 4 controlled into liquid-crystal molecular orientation corresponding to the electric field from the electrodes PE, CE. The electrodes PE, CE and the pixel region of the liquid-crystal layer 4 constitute liquid-crystal pixels PX.

All of the pixels PX have storage capacitors Cs. The storage capacitors Cs are obtained by electrically connecting a plurality of storage capacitor lines capacitively-coupled with a plurality of rows of pixel electrodes PE to the common electrode CE on the array substrate 2.

The control unit CNT includes the gate driver 10 and source driver 20 provided on the display panel DP. The control unit CNT further includes a controller 5, a common voltage generator circuit 6, a reference gradation voltage generator circuit 7, and a switching voltage generator circuit 8.

The controller 5 controls the common voltage generator circuit 6, reference gradation voltage generator circuit 7, gate driver 10, and source driver 20 to display an image based on the digital video signal normally supplied from the outside on the liquid-crystal display panel OCBDP. The common voltage generator circuit 6 generates a common voltage Vcom for the common electrode CE on the counter-substrate 3. The reference gradation voltage generator circuit 7 generates a specific number of reference gradation voltages VREF. The reference gradation voltages VREF are used to convert, for example, a 6-bit display signal obtained for each pixel PX from the video signal VIDEO into a pixel voltage Vs. The pixel voltage Vs is a voltage applied to the pixel electrode PE using the potential of the common electrode CE as a reference.

The controller 5 generates a control signal CTY for selecting a plurality of gate lines Y sequentially in each vertical scanning period and a control signal CTX for allocating the display signals for a row of pixels PX included in a video signal to a plurality of source lines X in each horizontal scanning period (1H). Here, the control signal CTX includes a horizontal start signal STH which is a pulse generated in each horizontal scanning period (1H) and a horizontal clock signal CKH which is as many pulses as there are source lines in each horizontal scanning period. The control signal CTY is supplied from the controller 5 to the gate driver 10. The control signal CTX, together with a digital video signal VIDEO, is supplied from the controller 5 to the source driver 20.

The gate driver 10 selects a plurality of gate lines Y sequentially under the control of the control signal CTY and supplies a scanning signal that causes a pixel switching element W to conduct to the select gate line Y. In the embodiment, a plurality of pixels PX are selected row by row in a horizontal scanning period.

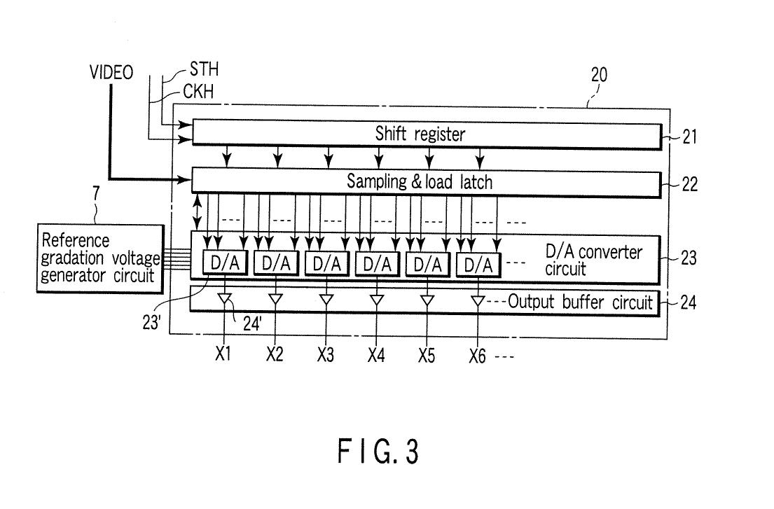

FIG. 3 schematically shows the configuration of the source driver 20 shown in FIG. 2.

The source driver 20 includes a shift register 21, a sampling & load latch 22, a digital-analog (DA) converter circuit 23, and an output buffer 24.

The shift register 21 shifts a horizontal start signal STH in synchronization with a horizontal clock signal CKH, thereby controlling the timing of making a serial parallel conversion of the digital video signal VIDEO sequentially. The sampling & load latch 22 latches the digital video signal VIDEO sequentially under the control of the shift register 21, thereby outputting a display signal for a row of pixels PX in parallel. The digital analog (DA) converter circuit 23 converts the display signal into an analog pixel voltage Vs. The output buffer circuit 24 amplifies the analog pixel voltage Vs obtained from the DA converter circuit 23.

The DA converter circuit 23 is configured to refer to a specific number of reference gradation voltages VREF generated at the reference gradation voltage generator circuit 7.

The DA converter circuit 23 is composed of a plurality of DA converting units 23′ known as, for example, resistor ladder DAC. Each of the DA converting units 23′ selects any one of the specific number of reference gradation voltages VREF on the basis of the digital display signal output from the sampling & load latch 22 and subjects the selected voltage to resistance voltage division, thereby converting the digital display signal into the corresponding pixel voltage Vs. The output buffer circuit 24 is composed of a plurality of buffer amplifiers 24′ which output the pixel voltages Vs from the plurality of DA converting units 23′ to source lines X1, X2, X3, . . . in a one-to-one correspondence.

With the liquid-crystal display device, in each horizontal scanning period that the gate driver 10 outputs a scanning signal to a gate line Y, the source driver 20 converts the display signal for a row of pixels PX included in the digital video signal into pixel voltages Vs and outputs the pixel voltages Vs to source lines X1 to Xn. The pixel voltages Vs on the source lines X1 to Xn are supplied to the corresponding pixel electrodes PE via a row of pixel switching elements W driven by the scanning signal.

The common voltage Vcom is output from the common voltage generator circuit 6 to the common electrode CE in synchronization with the output timing of the pixel voltages VS. According to the control signal from the controller 5, the common voltage generator circuit 6 outputs, for example, voltages of 0V and 5.8V alternately in each horizontal scanning period. For this reason, in the source driver 20, each of the DA converting units 23′ inverts the level of the pixel voltage Vs with the central level of the common voltage Vcom as a reference. When the liquid-crystal driving voltage, the potential difference between the pixel electrode PE and the common voltage CE, is maximized, the pixel voltage Vs is set to 5.8V for a 0V common voltage Vcom and is set to 0V for a 5.8V common voltage Vcom.

If the pixel voltage Vs is output at 5.8V from the source driver 20, it drops to, for example, about 4.8V due to the field-through voltage or the like caused by the parasitic capacitance of the pixel switching element W, which is then held at the pixel electrode PE. For this reason, the amplitude and central level of the common voltage Vcom output from the common voltage generator circuit 6 are adjusted beforehand in accordance with the pixel voltage Vs actually held at the pixel electrode PE.

The controller 5 controls the transmissive state of the liquid-crystal display panel PDDP via the switching voltage generator circuit 8.

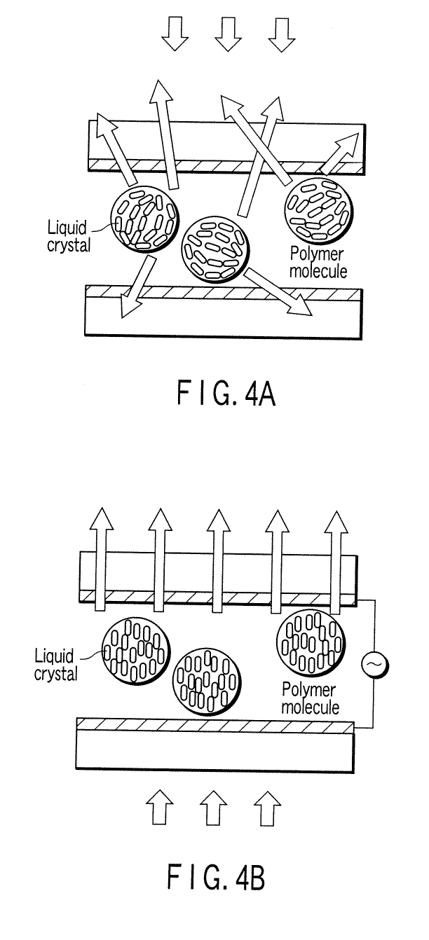

FIGS. 4A and 4B are diagrams to help explain the principle of switching transmissive states of polymer-dispersed liquid crystals.

Polymer-dispersed liquid crystals are formed by dispersing liquid crystals in, for example, polymer resin. The liquid-crystal molecules align in a directionless manner so as to be located along the polymer barrier diffusion when the applied voltage is zero. However, when a voltage is applied, the liquid-crystal molecules align in the direction of electric field.

Therefore, materials are so designed that, when the applied voltage is zero as shown in FIG. 4A, the refractive index of the polymer resin part differs from that of the liquid-crystal part and that, when a voltage is applied as shown in FIG. 4B, the refractive index of the polymer resin part coincides with that of the liquid-crystal part. As a result, controlling the applied voltage enables the scattering and transmission of the incident light to be controlled. That is, when the voltage is zero, the incident light can be scattered. When a voltage is applied, the incident light can be transmitted.

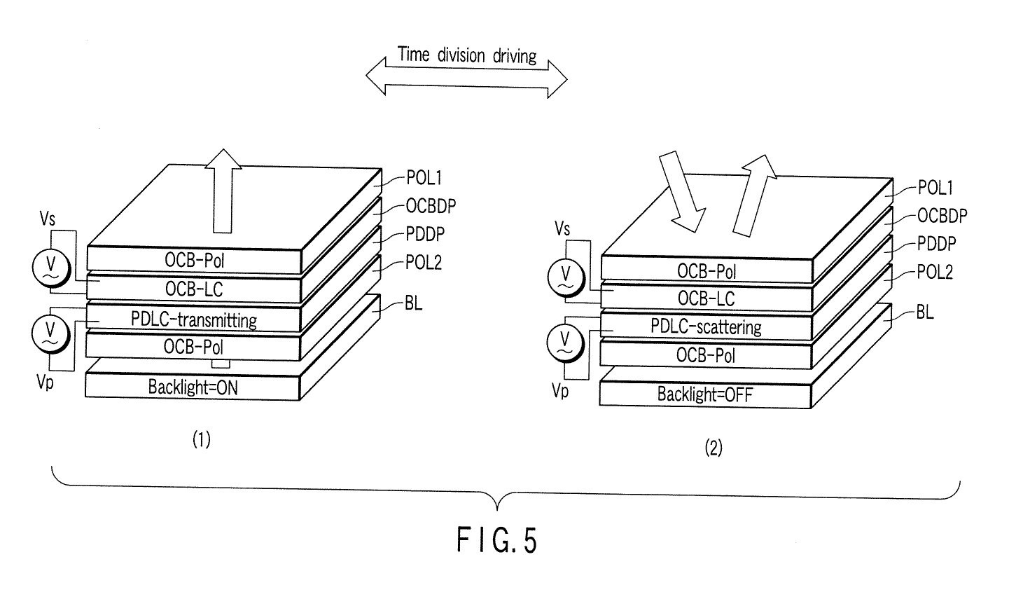

FIG. 5 is a diagram to help explain the display operation of the liquid-crystal display device of the embodiment.

In the embodiment, a display period in a transmissive mode and that in a reflective mode are provided in a one-frame display period. The two display periods are switched by time division.

FIG. 5 (1) shows a display state in the transmissive mode. In this state, the switching voltage generator circuit 8 applies a switching voltage Vp to the PDLC. Therefore, the light from the backlight BL passes through the PDLC. On the other hand, the pixel voltage Vs corresponding to the transmissive mode is applied to the OCB liquid-crystal pixel PX. Thus, the liquid-crystal display device displays an image in the transmissive mode.

FIG. 5 (2) shows a display state in the reflective mode. In this state, the operation of the backlight BL is stopped, preventing light from being generated at the backlight BL. Moreover, the switching voltage generator circuit 8 applies no switching voltage Vp to the PDLC. Consequently, after outside light entering the OCB liquid-crystal pixel PX has passed through the OCB liquid-crystal pixel PX, the light is reflected by the PDLC and passes through the OCB liquid-crystal pixel PX again and is emitted to the outside. On the other hand, a pixel voltage Vs corresponding to the reflective mode is applied to the OCB liquid-crystal pixel PX. Thus, the liquid-crystal display device displays an image in the reflective mode.

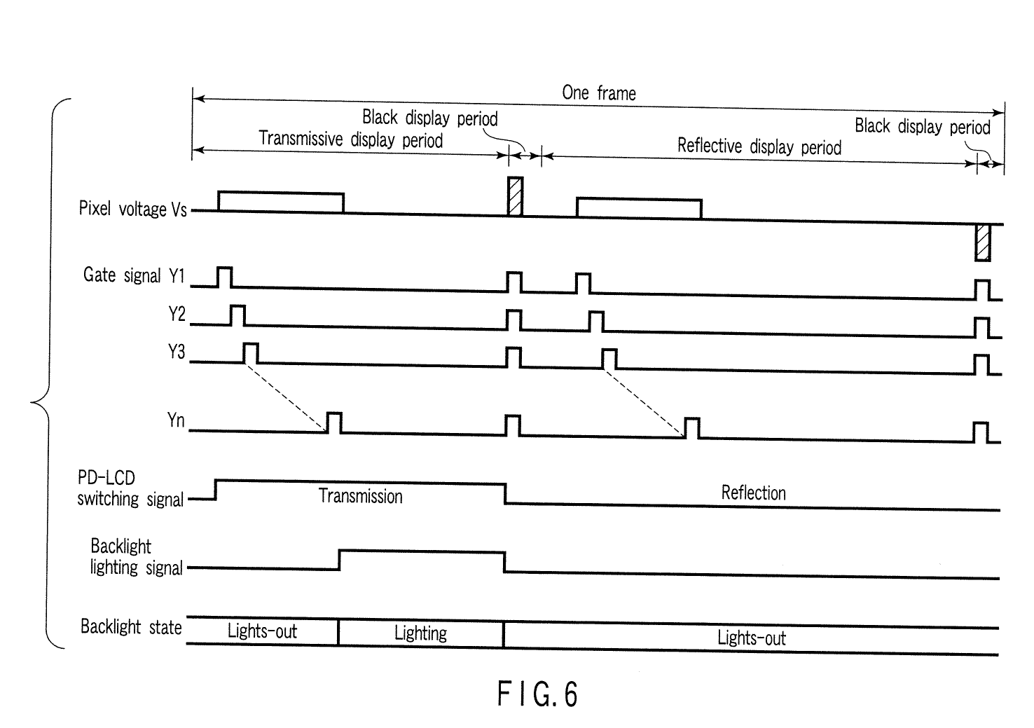

FIG. 6 is a time chart to help explain the display operation of the liquid-crystal display device of the embodiment.

In a display period in the transmissive mode (hereinafter, referred to as a transmissive display period) in one frame, a voltage is applied to a PDLCD switching signal, thereby switching the PDLCD to the transmissive state. Then, as described above, the gate driver 10 selects a plurality of gate lines Y under the control of the control signal CTY from the controller 5 and supplies a scanning signal for causing the pixel switching element W to conduct to the selected gate lines Y. As a result, a plurality of pixels P are selected row by row sequentially in each horizontal scanning period.

The reference gradation voltage generator circuit 7 generates a specific number of reference gradation voltages VREF for the transmissive mode. The source driver 20 converts, for example, a 6-bit display signal obtained from the video signal VIDEO on the basis of the reference gradation voltage VREF in synchronization with the selection timing of the gate line into the pixel voltages Vs corresponding to the transmissive mode and applies the resulting signals to the individual pixels PX.

The backlight BL is made unlit during a so-called write operation of selecting a gate line Y and applying the pixel voltage Vs to a pixel PX. Then, after all the gate lines Y have been selected and the write operation has been completed, the backlight BL is turned on. As described above, low power consumption can be realized by driving the backlight BL intermittently even in the transmissive display period. In the embodiment, an LED backlight capable of high-speed blinking is used as the backlight BL.

When the transmissive display period has been completed, the voltage of the PDLCD switching signal is made zero and the backlight BL is turned off. Then, a black display period for displaying a black signal is started.

Since in the black display period, a voltage is not applied to the PDLCD switching signal, the PDLCD is switched to the reflective state. Then, the gate driver 10 selects all the gate lines Y under the control of the control signal CTY from the controller 5 and supplies a scanning signal for causing the pixel switching element W to conduct to all the gate lines Y.

The reference gradation voltage generator circuit 7 generates a specific number of reference gradation voltages VREF for black display. The source driver 20 applies a black display signal as a pixel voltage Vs to all the pixels PX on the basis of the reference gradation voltage VREF in synchronization with the selection timing of all the gate lines.

When the black display period has lasted for a specific time and then ended, the state where the voltage of the PDLCD switching signal remains at zero and the backlight BL is unlit is continued and a display period in the reflective mode (hereinafter, referred to as a reflective display period) is started.

Since in the reflective display period, no voltage is applied to the PDLCD switching signal, the PDLCD remains in the reflective state. Then, as described above, the gate driver 10 selects a plurality of gate lines Y under the control of the control signal CTY from the controller 5 and supplies a scanning signal for causing the pixel switching element W to conduct to the selected gate lines Y. As a result, a plurality of pixels PX are selected row by row sequentially in each horizontal scanning period.

The reference gradation voltage generator circuit 7 generates a specific number of reference gradation voltages VREF for the reflective mode. The source driver 20 converts, for example, a 6-bit display signal obtained from the video signal VIDEO on the basis of the reference gradation voltage VREF in synchronization with the selection timing of the gate line into the pixel voltages Vs corresponding to the reflective mode and applies the resulting signals to the individual pixels PX.

In the reflective display period, the backlight BL is unlit. As described above, performing on-off control of the backlight BL in the transmissive display period and reflective display period enables low power consumption to be realized.

When the reflective display period has expired, the voltage of the PDLCD switching signal is made zero and the unlit state of the backlight is continued. Then, a black display period to display a black signal is started.

In the black display period, the gate driver 10 selects all the gate lines Y under the control of the control signal CTY from the controller 5 and supplies a scanning signal for causing the pixel switching element W to conduct to all the gate lines Y.

The reference gradation voltage generator circuit 7 generates a specific number of reference gradation voltages VREF for black display. The source driver 20 applies a black display signal as a pixel voltage Vs to all the pixels PX on the basis of the reference gradation voltage VREF in synchronization with the selection timing of all the gate lines. Since in the embodiment, OCB liquid crystals are used, it is desirable that the polarity of the black voltage applied here should be the reverse of that of the black voltage applied in the previous black display period.

The black display period is continued for a specific time. After the black display period has expired, a series of operations starting with the aforesaid transmissive display period are executed repeatedly.

The transmissive display period is not necessarily the same as the reflective display period. For example, the ratio of the transmissive display period to the reflective display period not only is 1:1 but also may be changed to 3:1, 1:3, or others.

Moreover, the ratio of the transmissive display period to the reflective display period may be changed suitably according to, for example, environmental illuminance on the basis of an outside light sensor. Specifically, in an environment where the environmental illuminance is high, such as in the open air, on the basis of an outside light sensor, the percentage of the reflective display period is increased in such a manner that the ratio of the transmissive display period to the reflective display period is set to 1:3 or 0:1. Conversely, in an environment where the environmental illuminance is low, such as in doors, on the basis of an outside light sensor, the percentage of the reflective display period is decreased in such a manner that the ratio of the transmissive display period to the reflective display period is set to 3:1 or 1:0.

By doing this, the power of the device can be used effectively.

While in the time chart of FIG. 6, intermittent driving has been done whereby the backlight BL is turned on after all the gate lines Y have been selected in the transmissive display period, the backlight BL may be turned on in the transmissive display period. By doing this, the display luminance can be increased, although the contrast drops as compared with the above intermittent driving method.

Furthermore, while in the time chart of FIG. 6, a black display is made simultaneously after the transmissive display period and reflective display period, a display may be made by black insertion driving sequentially after the completion of the write period. Specifically, the gate lines Y are selected sequentially and a scanning signal for causing the pixel switching element W to conduct is supplied to the selected gate Y. Then, in accordance with the selection of the gate line, a black signal is supplied to the pixels PX in the selected row. The operation of inserting black signals sequentially may be incorporated into the operation of supplying a video signal.

While in the embodiment, one frame has been divided into a transmissive display period→a black display period→a reflective display period→a black display period in that order and a display operation has been repeated in a time-series manner, one frame may be divided into a transmissive display period→a reflective display period in that order and a display operation may be repeated in a time-series manner. Then, a black display period may be provided in each of the transmissive display period and reflective display period.

As descried above, the embodiment produces various effects.

A conventional pixel was configured to have a transmissive part and a reflective part and had a complex structure with a step in it. Accordingly, it was pointed out that light was absorbed or reflected diffusely inside the device, resulting in a low use efficiency of light. In contrast, with this invention, since the pixels don't have such a complex structure, light can be used efficiently.

As for use of the backlight, the backlight had to be constantly lighted since the transmissive region and reflective region were mixed in a pixel in a conventional device. In the invention, however, the backlight has only to be selectively lighted only in the transmissive display period or intermittently lighted even in the transmissive display period, which enables low power consumption to be achieved. Of course, as in the conventional device, the backlight may be lighted continuously to simplify the circuit configuration instead of blinking the backlight.

Since the display device of the invention has such a simple configuration as has a liquid-crystal panel and a PDLC stacked one on top of the other, a pixel having a complex shape, such as a step, need not be manufactured, which enables manufacturing costs to be reduced remarkably.

As for the way the display characteristic of the transmissive mode and that of the reflective mode are caused to coincide with each other, an attempt was made in a conventional method to cause the display characteristics to coincide with each other using the structure of a pixel, but it was difficult to cause them to coincide with each other completely. In the embodiment, however, since it is possible to switch between the transmissive display and the reflective display by a time-division system, each of them can be driven at the optimum driving voltage, which enables a good display image to be obtained.

Furthermore, using an outside sensor or the like, the ratio of the transmissive display period to the reflective display period is changed to the optimum ratio as needed, which enables the best display image to be obtained without increasing the power consumption.

While in the embodiment, the display device using OCB liquid crystals has been explained, the invention is not limited to this. The invention may use suitable material which is neither an OCB liquid crystal nor a liquid crystal.

Moreover, while a PDLC has been used as means for selecting light transmission or light reflection, various means other than the PDLC may be used.

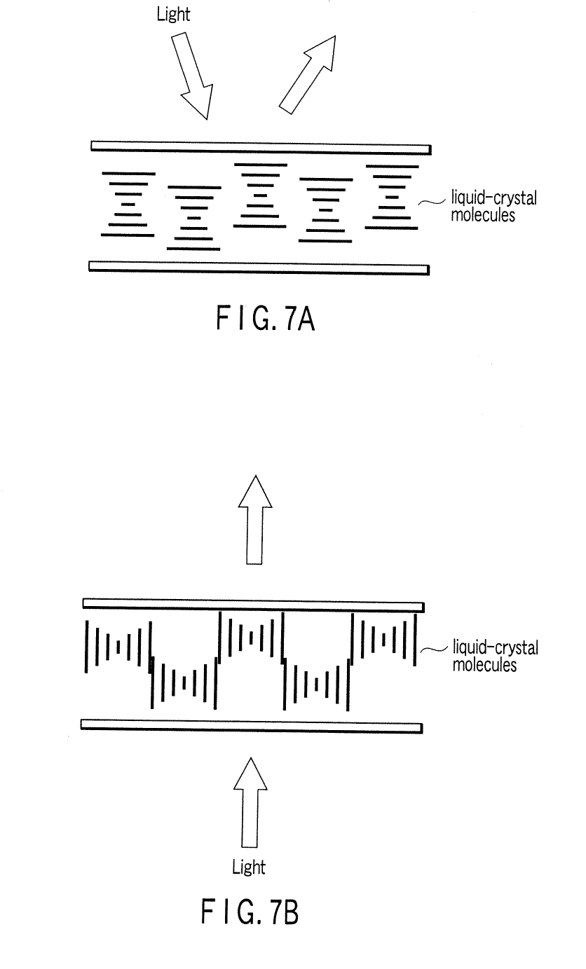

FIGS. 7A and 7B are diagrams to help explain the principle of switching transmissive states by use of cholesteric liquid crystals.

A cholesteric liquid crystal is a liquid-crystal composition obtained by adding chiral material to a nematic liquid crystal. Adjusting the electric field strength applied to the cholesteric liquid crystal makes it possible to switch between a planar state in which light is reflected as shown in FIG. 7A and a focal conic state in which light is allowed to passed through as shown in FIG. 7B. Accordingly, as with the PDLC, it is possible to select light transmission or light reflection.

The cholesteric liquid crystal has the property of being capable of maintaining its state stably without applying an electric field strength once having gone into the planar state or the focal conic state.

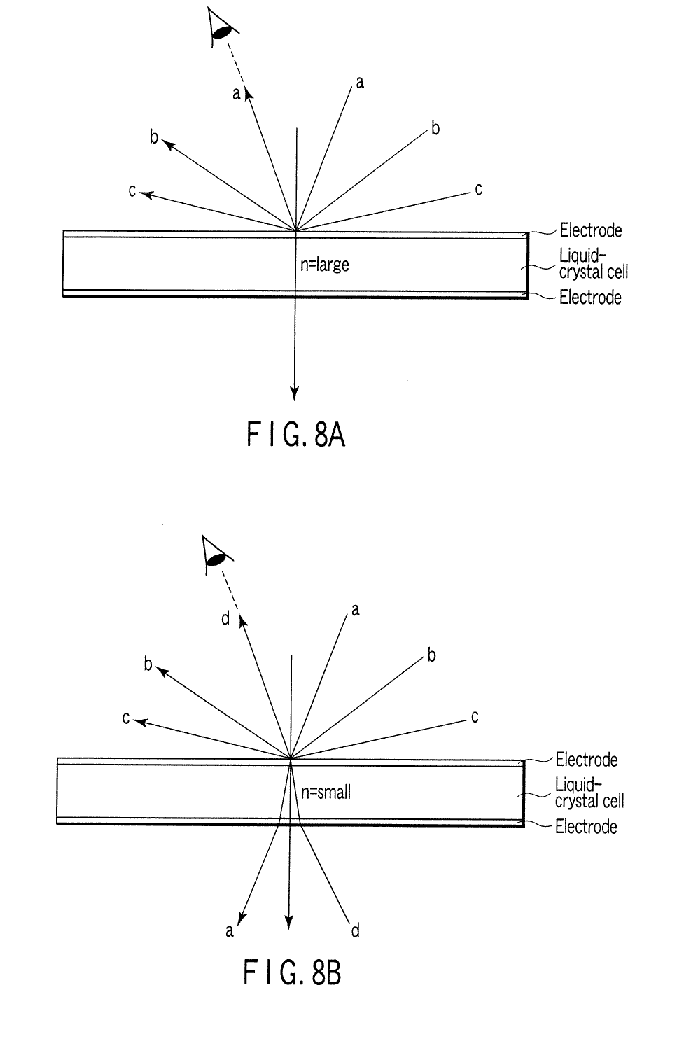

FIGS. 8A and 8B are diagrams to help explain the principle of switching transmissive states by use of liquid-crystal cells.

Liquid-crystal cells held between transparent electrodes, such as ITO, in place of the PDLC are provided. Then, adjusting a voltage applied to the liquid-crystal cells causes the refractive indexes of the liquid-crystal cells to be switched, thereby changing the total reflection condition.

FIG. 8A shows a case where the refractive index of a liquid-crystal cell is large. When the refractive index is large, the angle at which incident light is totally reflected becomes small, with the result that light a received at the monitoring position in FIG. 8A is reflected light. FIG. 8B shows a case where the refractive index of a liquid-crystal cell is small. When the refractive index is small, the angle at which incident light is totally reflected becomes large, with the result that light d received at the monitoring position in FIG. 8B is transmitted light.

Accordingly, when the display is monitored in the front, all the light monitored is transmitted light. When the display is monitored diagonally at an angle in a specific range, the liquid-crystal cell can switch between light transmission and light reflection.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a display panel in which pixels are arranged in a matrix;
a light source which is provided to face the display panel and illuminates one face of the display panel;
selecting means which is provided between the display panel and the light source and is configured to transmit or reflect light; and
control means for generating a frame which is time-shared by a transmissive display state produced by light from the light source, transmissive control of the selecting means, and display control of the display panel, and a reflective display state produced by reflective control of the selecting means and display control of the display panel.

2. The display apparatus according to claim 1, wherein the control means further controls the turning on and off of the light source.

3. The display apparatus according to claim 1, wherein the control means turns on or off the light source according to the transmissive display state or the reflective display state.

4. The display apparatus according to claim 1, wherein the light source is configured using an LED.

5. The display apparatus according to claim 1, wherein the pixels are configured using OCB liquid crystals.

6. The display apparatus according to claim 1, wherein the control for generating a frame further time-shared by a black display state produced by display control of the display panel.

7. A method of driving a display apparatus which includes a display panel in which pixels are arranged in a matrix, a light source which is provided to face the display panel and illuminates one face of the display panel, selecting means which is provided between the display panel and the light source and is configured to transmit or reflect light, and control means which controls the display of the display panel and the transmission or reflection of the selecting means,
wherein the control means makes time division using a transmissive display state produced by light from the light source, transmissive control of the selecting means, and display control of the display panel and a reflective display state produced by reflective control by the selecting means and display control of the display panel, thereby creating a frame.

8. The method of driving the display apparatus according to claim 7, wherein the control means further controls the turning on and off of the light source.

9. The method of driving the display apparatus according to claim 1, wherein the control means turns on or off the light source according to the transmissive display state or the reflective display state.

10. The method of driving the display apparatus according to claim 1, wherein the light source is configured using an LED.

11. The method of driving the display apparatus according to claim 1, wherein the pixels are configured using OCB liquid crystals.

12. The method of driving the display apparatus according to claim 7, wherein the control means makes time division further using a black display state produced by display control of the display panel, thereby creating a frame.
